(19) United States
(12) Patent Application Publication
(10) Pub. No.: US 2024/0093997 A1
(43) Pub. Date: Mar. 21, 2024

(54) Inertial Measurement Device

(71) Applicant: SEIKO EPSON CORPORATION, Tokyo (JP)

(72) Inventors: Taketo CHINO, Hokuto (JP); Yoshiyuki MATSUURA, Shiojiri (JP)

(21) Appl. No.: 18/467,235

(22) Filed: Sep. 14, 2023

(30) Foreign Application Priority Data
Sep. 15, 2022 (JP) 2022-146828

(51) Int. Cl. G01C 19/5783; G01P 1/02; G01P 15/18

(52) U.S. Cl. CPC G01C 19/5783; G01P 1/023; G01P 15/18

(57) ABSTRACT

An inertial measurement device includes: a board; a first inertial sensor configured to detect a physical quantity of a first axis and disposed perpendicular to the board; a rigid case configured to cover the first inertial sensor; and a filling material disposed between the first inertial sensor and the case.

The present application is based on, and claims priority from JP Application Serial Number 2022-146828, filed on Sep. 15, 2022, the disclosure of which is hereby incorporated by reference herein in its entirety.

### BACKGROUND

### 1. Technical Field

The present disclosure relates to an inertial measurement device.

### 2. Related Art

There is known an inertial measurement device including a plurality of inertial sensors such as an acceleration sensor and an angular velocity sensor. For example, JP-A-2017-20829 discloses a sensor unit including a six-axis motion sensor including an acceleration sensor of three axes and angular velocity sensors of three axes. According to this document, among the angular velocity sensors of three axes, a Z-axis angular velocity sensor is mounted on a first surface of a board, an X-axis angular velocity sensor is mounted on a side surface of the board in an X-axis direction, and a Y-axis angular velocity sensor is mounted on a side surface of the board in a Y-axis direction. The board on which a plurality of inertial sensors are mounted is accommodated in a metal case.

According to this document, a recess is formed in an aluminum inner case, and electronic components including the Z-axis angular velocity sensor mounted on the first surface of the board is accommodated in a space formed by the board and the recess. The space is filled with a filling material, thereby reducing influence of external noise and vibration and improving stability in detection accuracy.

Electronic components are also mounted on a second surface side, which is an opposite side of the board from the first surface, but no filling material is provided on the second surface side, and lower sides of the X-axis angular velocity sensor and the Y-axis angular velocity sensor mounted on side surfaces of the board are exposed from the filling material.

The sensor unit disclosed in JP-A-2017-20829 has room for improvement. Specifically, a stress may be non-uniform due to a fact that the filling material is provided only on a first surface side of the board. For example, when moisture enters from the second surface side of the board and the filling material absorbs the moisture, the filling material may expand. At this time, the expansion of the filling material does not occur on the first surface side backed by the highly rigid inner case, but occurs on the second surface side of the board, and bends the board to push the board toward the second surface side. This bending may affect the detection accuracy of the angular velocity sensors.

That is, an inertial measurement device having excellent moisture resistance and high detection accuracy has been required.

### SUMMARY

According to an aspect of the present application, there is provided an inertial measurement device including: a board; a first inertial sensor configured to detect a physical quantity of a first axis and disposed perpendicular to the board; a rigid case configured to cover the first inertial sensor; and a filling material disposed between the first inertial sensor and the case.

### BRIEF DESCRIPTION OF THE DRAWINGS

FIG. 1 is a perspective view showing a mode of fixing an inertial measurement device according to a first embodiment to a mounting target surface.

FIG. 2 is a perspective view of the inertial measurement device observed from a mounting target surface side.

FIG. 3 is an exploded perspective view of the inertial measurement device.

FIG. 4 is a perspective view of a circuit board.

FIG. 5 is a perspective cross-sectional view taken along a line f-f in FIG. 2.

FIG. 6 is a cross-sectional view taken along the line f-f in FIG. 2.

FIG. 7 is a cross-sectional view taken along a line b-b in FIG. 1.

FIG. 8 is a plan view of an inner case.

FIG. 9 is a plan view of an outer case.

FIG. 10 is a transparent plan view of an angular velocity sensor.

FIG. 11 is a cross-sectional view taken along a line j-j in FIG. 10.

FIG. 12 is a plan view of a circuit board according to a second embodiment.

FIG. 13 is an enlarged view from a P view in FIG. 12.

FIG. 14 is a cross-sectional view of an inertial measurement device according to the second embodiment.

FIG. 15 is a perspective view of a circuit board according to a modification.

FIG. 16 is a cross-sectional view of an inertial measurement device according to a modification.

FIG. 17 is a plan view of a circuit board according to a third embodiment.

FIG. 18 is a perspective view of an angular velocity sensor according to the third embodiment.

FIG. 19 is a cross-sectional view of an inertial measurement device according to the third embodiment.

FIG. 20 is a plan view of a circuit board according to a fourth embodiment.

FIG. 21 is a cross-sectional view of an inertial measurement device according to the fourth embodiment.

FIG. 22 is a cross-sectional view of an inertial measurement device according to a fifth embodiment.

FIG. 23 is a perspective view of a circuit board according to a sixth embodiment.

FIG. 24 is a cross-sectional view of an inertial measurement device according to the sixth embodiment.

### DESCRIPTION OF EMBODIMENTS

### First Embodiment

Outline of Inertial Measurement Device

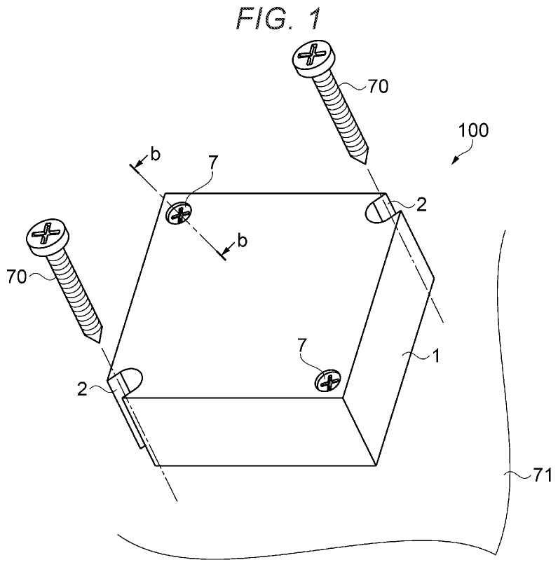

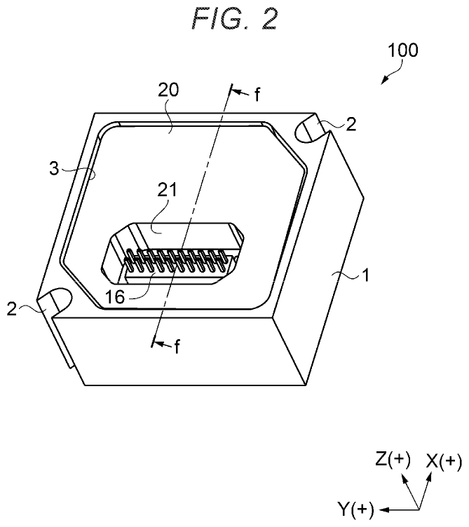

FIG. 1 is a perspective view showing a mode of fixing an inertial measurement device according to a first embodiment to a mounting target surface. FIG. 2 is a perspective view of the inertial measurement device observed from a mounting target surface side.

First, an outline of an inertial measurement device 100 according to the embodiment will be described.

The inertial measurement device 100 shown in FIG. 1 is an inertial measurement unit (IMU) that detects the posture and behavior of a mounting target body such as an automobile or a robot. The inertial measurement device 100 includes angular velocity sensors of three axes.

The inertial measurement device 100 is formed into a rectangular parallelepiped having a substantially square shape in a plan view, and is compactly formed such that a length of one side of the square is approximately several centimeters. Two cutout holes 2 are formed in a diagonal direction of the inertial measurement device 100. The inertial measurement device 100 is fixed to a mounting target surface 71 of a mounting target body such as an automobile by two attachment screws 70 inserted into the cutout holes 2. The mounting target body is not limited to a moving body such as an automobile, and may be a structure such as a bridge, an elevated road, or a track. When being mounted to a structure, the inertial measurement device 100 is used as a structural health monitoring system that checks health of the structure.

Basic Configuration of Inertial Measurement Device

As shown in FIG. 2, the inertial measurement device 100 has a configuration in which an inner case 20 is accommodated in an outer case 1 having a rectangular parallelepiped shape. A rectangular opening 21 is formed in the inner case 20. Hereinafter, a long side direction of the opening 21 is defined as a Y(+) direction. As indicated by coordinate axes in the following description, a direction orthogonal to the Y(+) direction is defined as an X(+) direction, and a thickness direction of the outer case 1 is defined as Z(+). A plug-type connector 16 is exposed from the opening 21 of the inner case 20, and the Y(+) direction coincides with an arrangement direction of a plurality of pins of the connector 16.

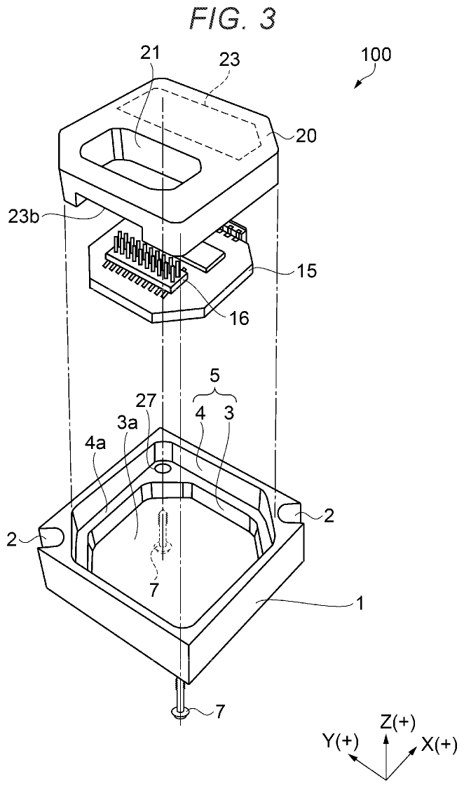

FIG. 3 is an exploded perspective view of the inertial measurement device.

As shown in FIG. 3, the inertial measurement device 100 includes the outer case 1, a circuit board 15 as a board, and the inner case 20. The inner case 20 corresponds to a first case, and the outer case 1 corresponds to a second case.

The outer case 1 is a box-shaped housing having a rectangular parallelepiped outer shape. In a preferred example, aluminum is used as a material. The material is not limited to aluminum, and may be any highly rigid material that does not swell, such as metal or ceramic. Titanium, magnesium, or stainless steel may be used as the metal. The outer case 1 and the inner case 20 are preferably made of the same material.

The two cutout holes 2 described above are formed in an outer side of the outer case 1. The configuration is not limited to the cutout hole 2, and for example, a round hole (through hole) may be formed and screwed, or a flange (ear) may be formed on a side surface of the outer case 1 and the flange portion may be screwed.

The outer case 1 includes an accommodating portion 5 that accommodates the inner case 20 in which the circuit board 15 is set.

The accommodating portion 5 includes a board accommodating portion 3 having a bottom 3a as a base and a main accommodating portion 4 surrounding the board accommodating portion 3. A receiving portion 4a is formed between the board accommodating portion 3 and the main accommodating portion 4. The receiving portion 4a is a ring-shaped stopper portion rising stepwise from the bottom 3a, and supports an outer peripheral edge of the inner case 20. The inner case 20 is accommodated in the main accommodating portion 4, and the circuit board 15 is accommodated in the board accommodating portion 3.

In other words, the inner case 20 as the first case is accommodated in the accommodating portion 5 of the outer case 1 as the second case, and the accommodating portion 5 includes the receiving portion 4a as the stopper portion for preventing the inner case 20 from falling.

The inner case 20 is a member that supports the circuit board 15, and has a shape capable of being accommodated in the main accommodating portion 4 of the outer case 1. The inner case 20 is made of the same material as that of the outer case 1, and is made of aluminum in a preferred example. In other words, the outer case 1 and the inner case 20 as a case have rigidity.

The inner case 20 has the opening 21 for exposing the connector 16 on the circuit board 15 to the outside, and a cavity 23 that is a recess for accommodating an electronic component mounted on the circuit board 15. In other words, the circuit board 15 is disposed in a space, which is formed by the inner case 20 and the outer case 1 and includes the cavity 23 and the accommodating portion 5. Although the cavity 23 is actually filled with resin, the resin is not shown in FIG. 3. The board accommodating portion 3 of the accommodating portion 5 in the outer case 1 is also filled with resin in the same manner, but the resin is not shown in FIG. 3.

As shown in FIG. 3, the outer case 1 and the inner case 20 are fixed by two fixing screws 7 in a state in which the inner case 20 including the circuit board 15 is accommodated in and integrated with the accommodating portion 5 of the outer case 1. The two fixing screws 7 are provided at diagonal positions (see FIG. 1) different from the two cutout holes 2 for mounting the inertial measurement device 100. A case structure is not limited to that in which the inner case 20 is accommodated in the outer case 1, and any case structure capable of accommodating the circuit board 15 and having rigidity may be used. For example, a case structure may be used in which an upper case and a lower case, which are box bodies having the same size in a plan view, are integrated by causing accommodating portions of both cases to abut against each other.

Configuration of Circuit Board

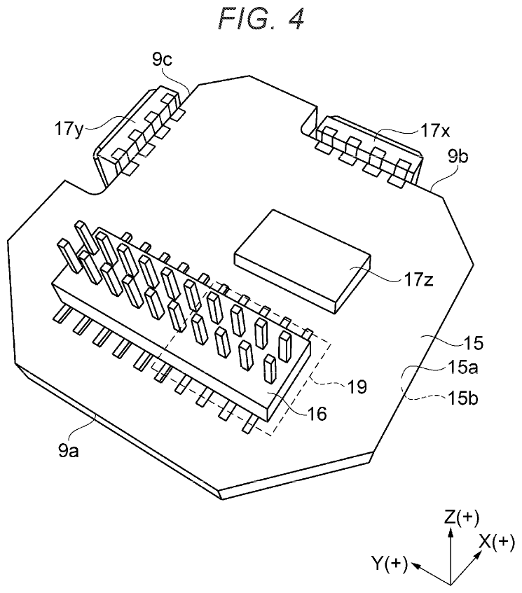

FIG. 4 is a perspective view of the circuit board.

The circuit board 15 is a multilayer glass epoxy board in a preferred example. An outer shape of the circuit board 15 is a deformed octagonal shape with some parts cut off in a plan view. The board is not limited to the glass epoxy board, and any rigid board may be used on which electronic components can be mounted. For example, a composite board may be used. A surface of the circuit board 15 on a Z(+) side is referred to as a first surface 15a, and an opposite-side surface thereof from the first surface 15a is referred to as a second surface 15b. The first surface 15a is also referred to as a front surface, and the second surface 15b is also referred to as a back surface. In the circuit board 15, electronic components are also mounted on side surfaces of the board.

As shown in FIG. 4, the connector 16 extends along a side surface 9a of the circuit board 15. The connector 16 is a plug-type connector, and includes two rows of coupling terminals arranged at an equal pitch along the Y(+) direction. A shroud-type connector including a wall surrounding the coupling terminals may also be used.

In addition to the connector 16, three angular velocity sensors 17x, 17y, and 17z, a control IC 19, and the like are mounted on the circuit board 15.

The angular velocity sensor 17x is a gyro sensor that detects an angular velocity around an X axis, and is mounted on a side surface 9b as a first side surface of the circuit board 15 in the X(+) direction. A vibrating gyro sensor that uses quartz crystal as a vibrator and that detects an angular velocity based on a Coriolis force applied to a vibrating object is used in a preferred example. The sensor is not limited to the vibrating gyro sensor, and may be any sensor capable of detecting an angular velocity. For example, a sensor using ceramic or silicon may be used as a vibrator.

The angular velocity sensor 17y is a gyro sensor that detects an angular velocity around a Y axis, and is mounted on a side surface 9c as a second side surface of the circuit board 15 in the Y(+) direction.

The angular velocity sensor 17z is a gyro sensor that detects an angular velocity around a Z axis, and is mounted on the first surface 15a of the circuit board 15. The angular velocity sensor 17y and the angular velocity sensor 17z are the same gyro sensor as the angular velocity sensor 17x, and these sensors correspond to inertial sensors.

In other words, the inertial measurement device 100 includes the circuit board 15, the angular velocity sensor 17x as a first inertial sensor that detects the angular velocity around the X axis as a physical quantity of a first axis and that is disposed perpendicular to the circuit board 15, the inner case 20 and the outer case 1 as a rigid case that covers the angular velocity sensor 17x, a filling material 31 disposed between the angular velocity sensor 17x and the inner case 20, and a filling material 32 disposed between the angular velocity sensor 17x and the outer case 1.

The angular velocity sensor 17x is mounted on the side surface 9b serving as the first side surface of the circuit board 15. The inertial measurement device 100 further includes the angular velocity sensor 17y as a second inertial sensor that detects the angular velocity around the Y axis as a physical quantity of a second axis, and the angular velocity sensor 17z as a third inertial sensor that detects the angular velocity around the Z axis as a physical quantity of a third axis, the angular velocity sensor 17y is mounted on the side surface 9c different from the side surface 9b of circuit board 15, and the angular velocity sensor 17z is mounted on the first surface 15a of the circuit board 15 in parallel.

Since the angular velocity sensors 17x, 17y, and 17z use quartz crystal as vibrators, the angular velocity sensors 17x, 17y, and 17z have excellent temperature characteristics, are less likely to be affected by external noise or temperature, and have high detection accuracy, as compared with a gyro sensor element manufactured using a MEMS technique.

A plurality of other electronic components are mounted on the first surface 15a of the circuit board 15, but are not shown in the drawing.

The control IC 19 is mounted on the second surface 15b of the circuit board 15.

The control IC 19 is a micro controller unit (MCU), includes a built-in storage unit including a nonvolatile memory, and controls units of the inertial measurement device 100 in an integrated manner. The storage unit stores a program defining an order and contents for detecting an angular velocity, a program for incorporating detection data into packet data, accompanying data, and the like.

A plurality of electronic components other than the control IC 19 are also mounted on the second surface 15b, but are not shown in the drawing.

Arrangement Mode of Filling Material

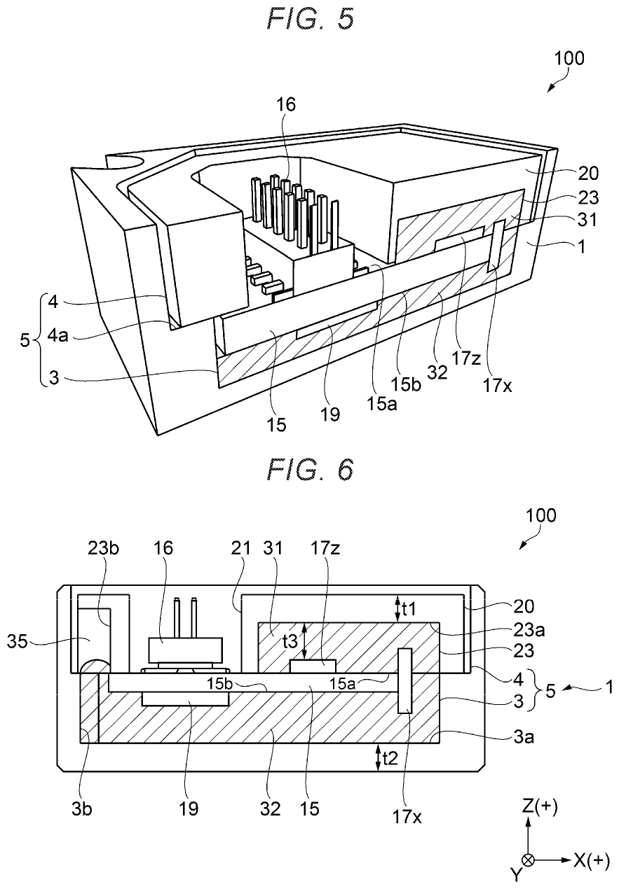

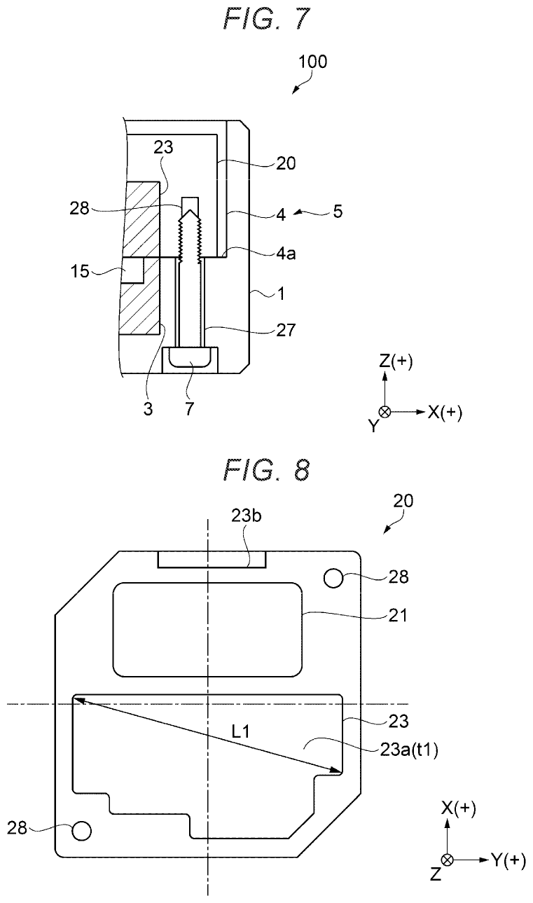

FIG. 5 is a perspective cross-sectional view taken along a line f-f in FIG. 2. FIG. 6 is a cross-sectional view taken along the line f-f in FIG. 2. FIG. 7 is a cross-sectional view taken along a line b-b in FIG. 1.

As shown in FIGS. 5 and 6, the circuit board 15 and the inner case 20 are accommodated in the accommodating portion 5 of the outer case 1.

Here, the cavity 23 of the inner case 20 is filled with the filling material 31 as a first filling material, and the board accommodating portion 3 of the outer case 1 is filled with the filling material 32 as a second filling material.

The filling material 31 covers the electronic components including the angular velocity sensor 17z and fills the cavity 23. Similarly, the filling material 32 covers the electronic components including the control IC 19 and fills the board accommodating portion 3. As shown in FIG. 6, the angular velocity sensor 17x mounted on the side surface of the circuit board 15 is also covered with the filling materials 31 and 32 on an upper side and a lower side as well as a rear side thereof. Similarly, the angular velocity sensor 17y is covered with the filling materials 31 and 32 all around.

A hard material having low hygroscopicity and a small coefficient of thermal expansion is suitable for the filling materials 31 and 32. In a preferred example, epoxy resin is used as the filling materials 31 and 32. Specifically, a one-liquid thermosetting epoxy adhesive is used. Hardness of the epoxy adhesive after curing is preferably 80D or more and more preferably 90D or more, as measured by a type D durometer in a durometer hardness test of JIS7215-1986. The epoxy resin containing a filler may be used.

A purpose of filling front and back surfaces of the circuit board 15 with the filling materials 31 and 32 is to prevent entry of humidity by sealing the angular velocity sensors 17x, 17y, and 17z with the filling materials 31 and 32, and to prevent warping of the circuit board 15 by integrating a first surface 15a side of the circuit board 15 with the inner case 20 and a second surface 15b side with the outer case 1. Therefore, the filling materials 31 and 32 are preferably made of resin having high hardness after curing.

In the related art, since the filling material 31 is provided on the first surface 15a side of the circuit board 15, and the second surface 15b side is not filled, lower sides of the angular velocity sensors 17x and 17y are exposed inside the board accommodating portion 3. Therefore, the angular velocity sensors 17x and 17y are affected by an external environment, such as the temperature, humidity, and vibration, and characteristics change, resulting in difficulty in highly accurate and highly stable detection. Since the angular velocity sensor 17z is filled with the filling material 31 all around, and the second surface 15b is exposed, influence of the external environment induces warping of the circuit board 15, affecting detection accuracy.

According to a method for assembling the inertial measurement device 100, first, the circuit board 15 is set in the inner case 20. Specifically, under an atmospheric pressure, the cavity 23 is filled with the filling material 31, and then the circuit board 15 is set. Next, under the atmospheric pressure, the inner case 20 including the circuit board 15 is set to the outer case 1 in which the board accommodating portion 3 is filled with the filling material 32. The above steps may be performed under a reduced pressure environment, or a step performed under the atmospheric pressure and a step performed under the reduced pressure environment may be combined.

As shown in FIG. 7, the fixing screw 7 is inserted into a through hole 27 of the outer case 1, and is screwed and fixed to a prepared hole 28 of the inner case 20. Two prepared holes 28 are formed at diagonal positions of the inner case 20 (FIG. 8). In a preferred example, after tightening the screws, the inertial measurement device 100 is set in a high-temperature environment, and the filling materials 31 and 32 are thermally cured. The filling material 31 may be cured first at a stage when the circuit board 15 is set in the inner case 20. Since the fixing screws 7 may be omitted and the front and back surfaces of the circuit board 15 are filled with the filling materials 31 and 32, a strength of the structure can be ensured only by an adhesive force of the filling materials 31 and 32.

Configuration Mode of Case

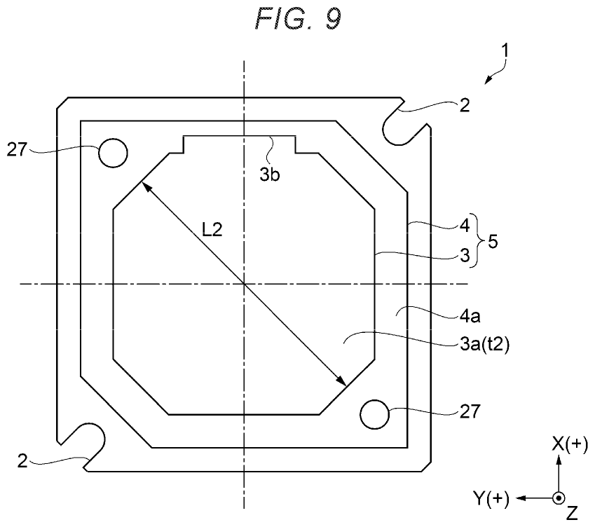

FIG. 8 is a plan view of the inner case. FIG. 9 is a plan view of the outer case.

FIG. 8 is a plan view of the inner case 20 viewed from an installation surface for the circuit board 15.

As described above, the inner case 20 and the outer case 1 are made of aluminum having high rigidity, and the cavity 23 filled with the filling material 31, the accommodating portion 5 filled with the filling material 32, and the like preferably have a structure capable of withstanding a stress due to swelling of the filling materials 31 and 32 or temperature variation.

As shown in FIG. 8, the inner case 20 has a hexagonal shape obtained by cutting one of diagonal portions of a square. The other of the diagonal portions has two prepared holes 28 into which the two fixing screws 7 are screwed.

The substantially rectangular cavity 23 is formed in an X minus direction of the rectangular opening 21. Here, a width of the cavity 23 is defined as a length L1. When a thickness of a bottom 23a (FIG. 6) of the cavity 23 is defined as a thickness t1, the cavity 23 is designed to satisfy the following formula (1). When a length of any diagonal line among diagonal lines in a shape of the cavity 23 is defined as the length L1, the following formula (1) may be satisfied. When the longest diagonal line among the diagonal lines in the shape of the cavity 23 is defined as the length L1, it is preferable to satisfy the following formula (1). When a length of the widest portion of the cavity 23 is defined as the length L1, the following formula (1) may be satisfied.

L1/t1<20 Formula (1)

Note that t1 is 0.5 mm or more.

For example, when the length L1 of the cavity 23 is 18 mm and the thickness t1 of the bottom 23a is 2 mm, 18/2=9, which satisfies the formula (1).

As shown in FIG. 6, a depth of the cavity 23 is preferably set such that a dimension t3 from an upper surface of the angular velocity sensor 17z to the bottom 23a is 2 mm or less.

As shown in FIG. 9, the main accommodating portion 4 of the accommodating portion 5 of the outer case 1 has a shape along an outer shape of the hexagonal inner case 20. The substantially octagonal board accommodating portion 3 is formed inside the main accommodating portion 4.

Here, a width of the board accommodating portion 3 is defined as a length L2. When a thickness of the bottom 3a (FIG. 6) of the board accommodating portion 3 is defined as a thickness t2, the board accommodating portion 3 is designed to satisfy the following formula (2). When a length of any diagonal line among diagonal lines in a shape of the board accommodating portion 3 is defined as the length L2, the following formula (2) may be satisfied. When the longest diagonal line among the diagonal lines in the shape of the board accommodating portion 3 is defined as the length L2, it is preferable to satisfy the following formula (2). When a length of the widest portion of the board accommodating portion 3 is defined as the length L2, the following formula (2) may be satisfied.

L2/t2<20 Formula (2)

Note that t2 is 0.5 mm or more.

For example, when the length L2 of the board accommodating portion 3 is 21 mm and the thickness t2 of the bottom 3a is 2 mm, 21/2=10.5, which satisfies the formula (2).

In this way, according to verification results of the inventors and the like, it is confirmed that a structure capable of withstanding the stress due to the swelling of the filling materials 31 and 32 or the temperature variation is obtained by designing the cavity 23 of the inner case 20 and the board accommodating portion 3 of the outer case 1 in a manner of satisfying the formulas (1) and (2).

As shown in FIG. 9, a cutout portion 3b as a second cutout portion is formed on one side of the board accommodating portion 3 of the outer case 1. The cutout portion 3b is a portion obtained by cutting out a part of the receiving portion 4a to increase an area of the board accommodating portion 3.

As shown in FIG. 8, a cutout portion 23b as a first cutout portion is formed on one side of the outer shape of the inner case 20. The cutout portion 23b corresponds to the cutout portion 3b of the outer case 1, and is formed such that the two cutout portions 3b and 23b overlap each other when the inner case 20 is accommodated.

FIG. 6 shows a state in which the two cutout portions 3b and 23b overlap each other. Specifically, on an X minus side of the control IC 19, a storage portion 35 is shown which is a space formed by the cutout portion 3b and the cutout portion 23b overlapping in a Z direction. The storage portion 35 is a storage portion that stores the overflowed filling material 32 when the filling material 32 overflows. The storage portion 35 may be provided at a plurality of locations.

In other words, the cutout portion 23b is formed on the one side of the inner case 20, the cutout portion 3b is formed in the accommodating portion 5 of the outer case 1, and the storage portion 35 that stores the overflowed filling material 32 is formed by the cutout portion 23b and the cutout portion 3b when the inner case 20 is set in the accommodating portion 5 of the outer case 1.

Configuration of Angular Velocity Sensor

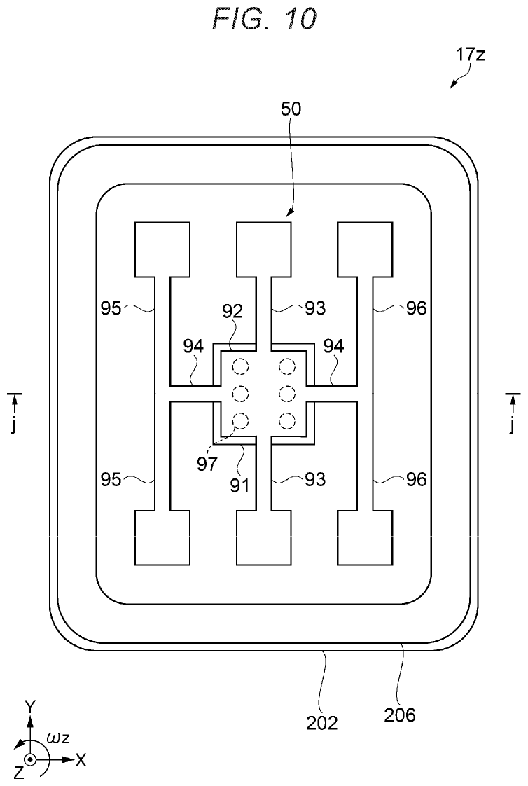

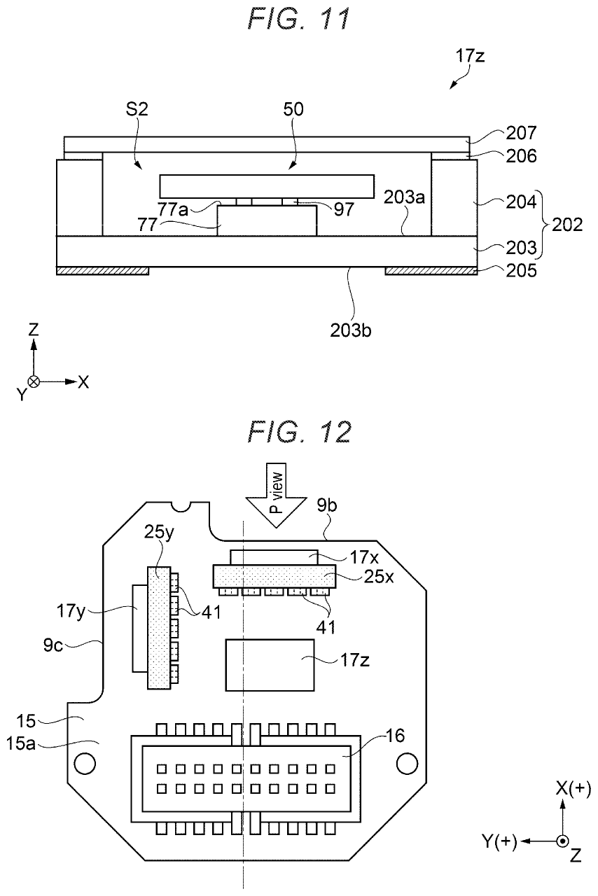

FIG. 10 is a transparent plan view of the angular velocity sensor. FIG. 11 is a cross-sectional view taken along a line j-j in FIG. 10.

Next, a configuration of the angular velocity sensor 17z will be described. The angular velocity sensor 17x and the angular velocity sensor 17y have the same configuration as that of the angular velocity sensor 17z.

The angular velocity sensor 17z shown in FIG. 10 includes a vibrating gyro sensor element 50. The vibrating gyro sensor element 50 is a gyro sensor element manufactured by processing a quartz crystal substrate using a photolithography technique, and detects an angular velocity by converting vibration of a detection vibrating arm into an electric signal. Since quartz crystal is used as a base material, temperature characteristics are excellent. Therefore, the gyro sensor element is less likely to be affected by external noise or temperature and has high detection accuracy as compared with the gyro sensor element manufactured using the MEMS technique. The vibrating gyro sensor element 50 is also referred to as an inertial sensor.

As shown in FIGS. 10 and 11, the angular velocity sensor 17z includes the vibrating gyro sensor element 50, a base 202 made of ceramic or the like for accommodating the vibrating gyro sensor element 50, and a lid 207 made of glass, ceramic, metal or the like.

The base 202 is formed by stacking a plate-shaped first substrate 203 and a frame-shaped second substrate 204. The base 202 has an accommodating space S2 that is open upward. The accommodating space S2 for accommodating the vibrating gyro sensor element 50 is hermetically sealed in a depressurized state, preferably in a state close to vacuum, by joining the lid 207 with a joining member 206 such as a seal ring.

A protrusion 77 protruding upward is formed on an upper surface 203a of the first substrate 203 of the base 202, and the vibrating gyro sensor element 50 is electrically and mechanically fixed to an upper surface 77a of the protrusion 77 via metal bumps 97 or the like. Therefore, contact between the vibrating gyro sensor element 50 and the first substrate 203 can be prevented.

A plurality of mounting terminals 205 are provided on a lower surface 203b of the first substrate 203 of the base 202. The mounting terminals 205 are electrically coupled to the vibrating gyro sensor element 50 via wirings that are not shown.

The vibrating gyro sensor element 50 includes a base portion 92 located in a central portion, a pair of detection vibrating arms 93 extending in a Y direction from the base portion 92, a pair of coupling arms 94 extending in an X direction from the base portion 92 in a manner of being orthogonal to the detection vibrating arms 93, and a pair of driving vibrating arms 95 and a pair of driving vibrating arms 96 each extending in the Y direction from a tip end side of the coupling arm 94 in a manner of being parallel to the detection vibrating arms 93. The vibrating gyro sensor element 50 is electrically and mechanically fixed to the upper surface 77a of the protrusion 77 provided on the base 202 via the metal bumps 97 or the like in the base portion 92.

When an angular velocity ωz around the Z axis is applied while the driving vibrating arms 95 and 96 are vibrating in a bending manner in the X direction in opposite phases, a Coriolis force in the Y direction acts on the driving vibrating arms 95 and 96 and the coupling arms 94, and the vibrating gyro sensor element 50 vibrates in the Y direction. This vibration causes the detection vibrating arms 93 to vibrate in a bending manner in the X direction. Therefore, the angular velocity ωz is obtained by detecting distortion of the quartz crystal generated by the vibration as an electric signal by detection electrodes formed on the detection vibrating arms 93.

As shown in FIG. 10, the vibrating gyro sensor element 50 of the angular velocity sensor 17z is orthogonal to an extending direction of the Z axis as a detection axis. A package type in which the vibrating gyro sensor element 50 is disposed parallel to the lower surface 203b of the base 202 is referred to as a horizontal package, in which the lower surface 203b of the base 202 is a mounting surface of the angular velocity sensor 17z. In other words, the angular velocity sensors 17x, 17y, and 17z are all horizontal packages.

As described above, according to the inertial measurement device 100 in the embodiment, the following effects can be attained.

The inertial measurement device 100 includes the circuit board 15, the angular velocity sensor 17x as the first inertial sensor that detects the angular velocity around the X axis as the physical quantity of the first axis and that is disposed perpendicular to the circuit board 15, the inner case 20 and the outer case 1 as the rigid case that covers the angular velocity sensor 17x, the filling material 31 disposed between the angular velocity sensor 17x and the inner case 20, and the filling material 32 disposed between the angular velocity sensor 17x and the outer case 1.

According to this, the first surface 15a side of the circuit board 15 is filled with the filling material 31, and the second surface 15b side is filled with the filling material 32. That is, the circuit board 15 is filled with the filling materials 31 and 32 on the front and back surfaces thereof, and is integrated with the inner case 20 and the outer case 1 to be rigid. This can prevent warping of the circuit board 15.

Further, since the filling material 31 is provided only on the first surface 15a side of the circuit board 15, different from the related-art configuration in which the lower sides of the angular velocity sensors 17x and 17y mounted on side surfaces of the circuit board 15 are exposed, in addition to upper and lower sides of the angular velocity sensors 17x and 17y, the rear sides thereof are also covered with the filling materials 31 and 32. Therefore, the influence of the external environment can be reduced.

Since the front and back surfaces and a peripheral edge portion of the circuit board 15 are almost covered with the filling materials 31 and 32, entry of moisture into the circuit board 15 can be prevented.

Therefore, it is possible to provide the inertial measurement device 100 having excellent moisture resistance and high detection accuracy.

The angular velocity sensor 17x is mounted on the side surface 9b as the first side surface of the circuit board 15. According to this, the vibrating gyro sensor element 50 of the angular velocity sensor 17x can be orthogonal to an extending direction of the X axis as a detection axis.

The inertial measurement device 100 further includes the angular velocity sensor 17y as the second inertial sensor that detects the angular velocity around the Y axis as the physical quantity of the second axis, and the angular velocity sensor 17z as the third inertial sensor that detects the angular velocity around the Z axis as the physical quantity of the third axis, the angular velocity sensor 17y is mounted on the side surface 9c different from the side surface 9b of the circuit board 15, and the angular velocity sensor 17z is mounted on the first surface 15a of the circuit board 15 in parallel.

According to this, the angular velocity sensors 17x, 17y, and 17z of three axes can be disposed at appropriate positions.

### Second Embodiment

Different Mounting Mode-1

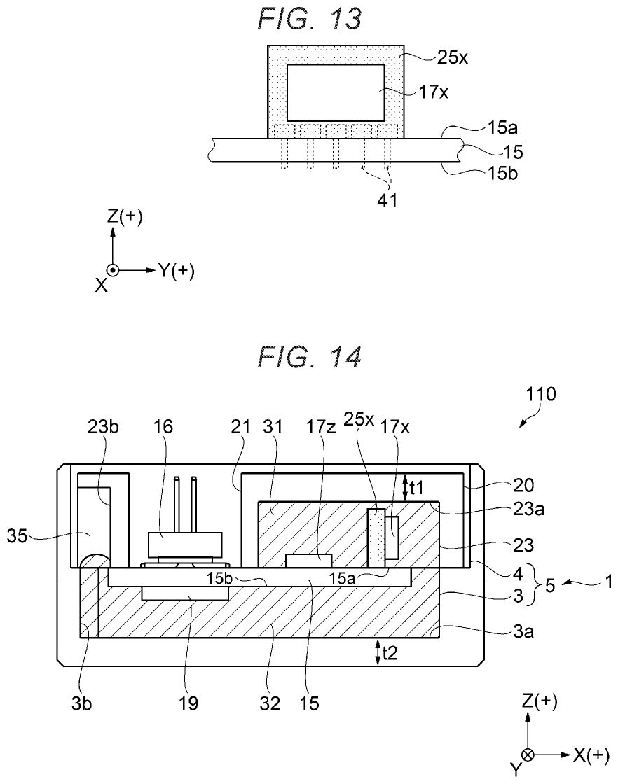

FIG. 12 is a plan view of a circuit board according to a second embodiment, and corresponds to FIG. 4. FIG. 13 is an enlarged view from a P view in FIG. 12. FIG. 14 is a cross-sectional view of an inertial measurement device, and corresponds to FIG. 6.

The angular velocity sensors 17x and 17y are mounted on the side surfaces 9b and 9c of the circuit board 15 in the above embodiment, but the disclosure is not limited to this configuration, and the angular velocity sensors 17x and 17y may be mounted on the first surface 15a. For example, in the embodiment, the angular velocity sensor 17x disposed in a vertical direction is provided at the first surface 15a of the circuit board 15. The angular velocity sensor 17x is mounted on a sub-board 25x provided in a state of being erected on the first surface 15a. The same applies to the angular velocity sensor 17y. Hereinafter, the same portions as those according to the above embodiment are denoted by the same reference signs, and redundant description thereof will be omitted.

In the embodiment, as shown in FIGS. 12 and 13, the angular velocity sensor 17x is disposed at the first surface 15a of the circuit board 15 while being mounted on the sub-board 25x as a relay board. As shown in FIG. 13, the sub-board 25x is a rectangular board one size larger than the angular velocity sensor 17x, and is disposed perpendicular to the circuit board 15. Similarly to the circuit board 15, a rigid board such as a glass epoxy board is used as the sub-board 25x. The angular velocity sensor 17x is mounted on a front surface of the sub-board 25x. A plurality of pin headers 41 are mounted on a back surface of the sub-board 25x. The pin headers 41 are rod-shaped metal components for coupling the two boards, and ends of the pins are inserted into via holes of the circuit board 15 to be soldered. The sub-board 25x is mounted in a state of being erected on the circuit board 15 by the plurality of pin headers 41. The sub-board 25x is disposed parallel to the side surface 9b of the circuit board 15 along an extending direction of the Y axis.

Accordingly, the angular velocity sensor 17x is orthogonal to the extending direction of the X axis as the detection axis.

The plurality of pin headers 41 also serve as electrical wiring between the sub-board 25x and the circuit board 15. Specifically, a drive voltage and a detection signal of the angular velocity sensor 17x are transmitted to and received from the circuit board 15 via the plurality of pin headers 41. A method is not limited to using the pin headers 41, and any method can be used as long as the sub-board can be mounted vertically on the circuit board 15. For example, a mounting terminal may be provided at a side surface of the sub-board 25x, or an L-shaped coupling fitting may be used.

In other words, the angular velocity sensor 17x as the first inertial sensor is electrically coupled to the circuit board 15 via the sub-board 25x as the relay board.

Similarly to the angular velocity sensor 17x, the angular velocity sensor 17y is disposed at the first surface 15a of the circuit board 15 while being mounted on a sub-board 25y.

The sub-board 25y is a board the same as the sub-board 25x, and is disposed perpendicular to the circuit board 15. Specifically, the angular velocity sensor 17y is mounted on a front surface of the sub-board 25y, and a plurality of pin headers 41 are mounted on a back surface thereof. The sub-board 25y is mounted in a state of being erected on the circuit board 15 by the plurality of pin headers 41. The sub-board 25y is disposed parallel to the side surface 9c of the circuit board 15 along the extending direction of the X-axis.

Accordingly, the angular velocity sensor 17y is orthogonal to the extending direction of the Y axis as a detection axis.

As shown in FIG. 14, in an inertial measurement device 110 according to the embodiment, the sub-board 25x including the angular velocity sensor 17x is accommodated in the cavity 23 of the inner case 20 and covered with the filling material 31. The same applies to the angular velocity sensor 17y, and the sub-board 25y including the angular velocity sensor 17y is accommodated in the cavity 23 and covered with the filling material 31.

In other words, according to the inertial measurement device 110, the angular velocity sensor 17x as the first inertial sensor is mounted perpendicularly to the first surface 15a of the circuit board 15. The angular velocity sensor 17y as the second inertial sensor is mounted perpendicularly to the first surface 15a of the circuit board 15, and the angular velocity sensor 17z as the third inertial sensor is mounted on the first surface 15a of the circuit board 15 in parallel. The inertial measurement device 110 includes the sub-board 25x as the relay board on which the angular velocity sensor 17x is mounted, the sub-board 25x is mounted perpendicularly to the circuit board 15, and the angular velocity sensor 17x is electrically coupled to the circuit board 15 via the sub-board 25x as the relay board.

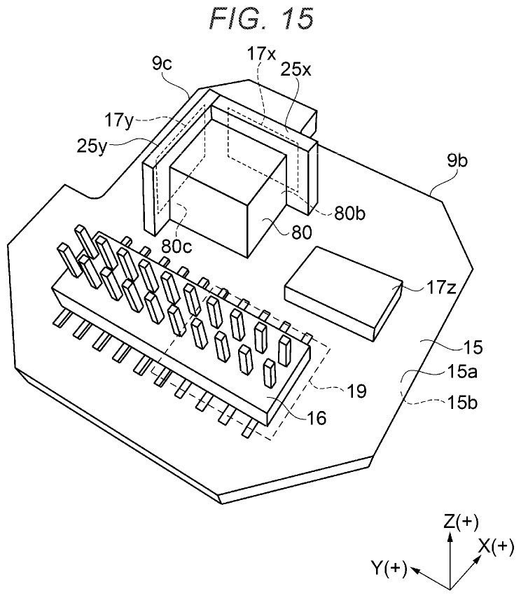

FIG. 15 is a perspective view of a circuit board according to a modification, and corresponds to FIG. 12. FIG. 16 is a cross-sectional view of an inertial measurement device according to a modification, and corresponds to FIG. 14.

The sub-board 25x is erected using the pin headers 41 in the above description, but the disclosure is not limited to this configuration, and any method may be used as long as the sub-board 25x can be erected. For example, in FIG. 15, the sub-board 25x is erected using a support member 80 having a rectangular parallelepiped shape. Hereinafter, the same portions as those described above are denoted by the same reference signs, and redundant description thereof will be omitted.

As shown in FIG. 15, the support member 80 is a rectangular parallelepiped member made of aluminum in a preferred example. The material is not limited to aluminum, and may be any rigid material such as other metals or resins. The support member 80 is fixed to the first surface 15a of the circuit board 15 with sides thereof extending along the X axis, the Y axis, and the Z axis.

The sub-board 25x is attached to a side surface 80b of the support member 80 on an X plus side, and the sub-board 25y is attached to a side surface 80c on a Y plus side. For example, a double-sided tape or an adhesive is used for the attachment.

The angular velocity sensor 17x is mounted on an opposite-side surface of the sub-board 25x from a surface for the attachment to the support member 80. Similarly, the angular velocity sensor 17y is mounted on an opposite-side surface of the sub-board 25y from a surface for the attachment to the support member 80.

A plurality of coupling terminals (not shown) are provided at a side surface of the sub-board 25x on the first surface 15a side of the circuit board 15, and electrical coupling with the circuit board 15 is established via the coupling terminals. Similarly, a plurality of coupling terminals (not shown) are provided at a side surface of the sub-board 25y on the first surface 15a side, and electrical coupling with the circuit board 15 is established via the coupling terminals.

In this way, orientations of the sub-boards 25x and 25y can be easily and accurately disposed using the rectangular parallelepiped support member 80. Accordingly, the angular velocity sensor 17x is disposed to be orthogonal to the extending direction of the X axis as the detection axis, and the angular velocity sensor 17y is disposed to be orthogonal to the extending direction of the Y axis as the detection axis.

As shown in FIG. 16, a flexible board 26x may be used.

The flexible board 26x is a strip-shaped flexible board, in which the angular velocity sensor 17x is mounted on one end side thereof, and the other end side thereof is soldered to the second surface 15b of the circuit board 15. The flexible board 26x electrically couples the angular velocity sensor 17x and the circuit board 15.

The support member 80 is disposed at the first surface 15a of the circuit board 15. The support member 80 is disposed such that the side surface 80b thereof is substantially flush with the side surface 9b of the circuit board 15.

As shown in FIG. 16, the flexible board 26x is bent near the side surface 9b of the circuit board 15, and the one end side thereof is attached to the side surface 80b of the support member 80. For example, a double-sided tape or an adhesive is used for the attachment. Similarly, the angular velocity sensor 17y is also mounted in an erected manner using a flexible board. A sub-board may be used instead of the support member 80.

Accordingly, the angular velocity sensor 17x is orthogonal to the extending direction of the X axis as the detection axis, and the angular velocity sensor 17y is orthogonal to the extending direction of the Y axis as the detection axis.

As described above, according to the inertial measurement device 110 in the embodiment, the following effects can be attained in addition to the effects according to the above embodiment.

According to the inertial measurement device 110, the angular velocity sensor 17x as the first inertial sensor is mounted perpendicularly to the first surface 15a of the circuit board 15. The angular velocity sensor 17y as the second inertial sensor is mounted perpendicularly to the first surface 15a of the circuit board 15, and the angular velocity sensor 17z as the third inertial sensor is mounted on the first surface 15a of the circuit board 15 in parallel.

According to this, the three angular velocity sensors 17x, 17y, and 17z are all mounted on the first surface 15a of the circuit board 15, and the first surface 15a side is filled with the filling material 31. The second surface 15b side of the circuit board 15 is filled with the filling material 32. Therefore, the circuit board 15 is filled with the filling materials 31 and 32 on the front and back surfaces thereof, and is integrated with the inner case 20 and the outer case 1 to be rigid. This can prevent warping of the circuit board 15.

Further, since the filling material 31 is provided only on the first surface 15a side of the circuit board 15, different from the related-art configuration in which the lower sides of the angular velocity sensors 17x and 17y mounted on the side surfaces of the circuit board 15 are exposed, the three angular velocity sensors 17x, 17y, and 17z are covered with the filling material 31 all around. Therefore, the influence of the external environment can be reduced.

Since the front and back surfaces and a peripheral edge portion of the circuit board 15 are almost covered with the filling materials 31 and 32, entry of moisture into the circuit board 15 can be prevented.

Therefore, it is possible to provide the inertial measurement device 110 having excellent moisture resistance and high detection accuracy.

The inertial measurement device 110 includes the sub-board 25x as the relay board on which the angular velocity sensor 17x is mounted, the sub-board 25x is mounted perpendicularly to the circuit board 15, and the angular velocity sensor 17x is electrically coupled to the circuit board 15 via the sub-board 25x as the relay board. According to this, the three angular velocity sensors 17x, 17y, and 17z can be compactly mounted on the first surface 15a of the circuit board 15.

### Third Embodiment

Different Mounting Mode-2

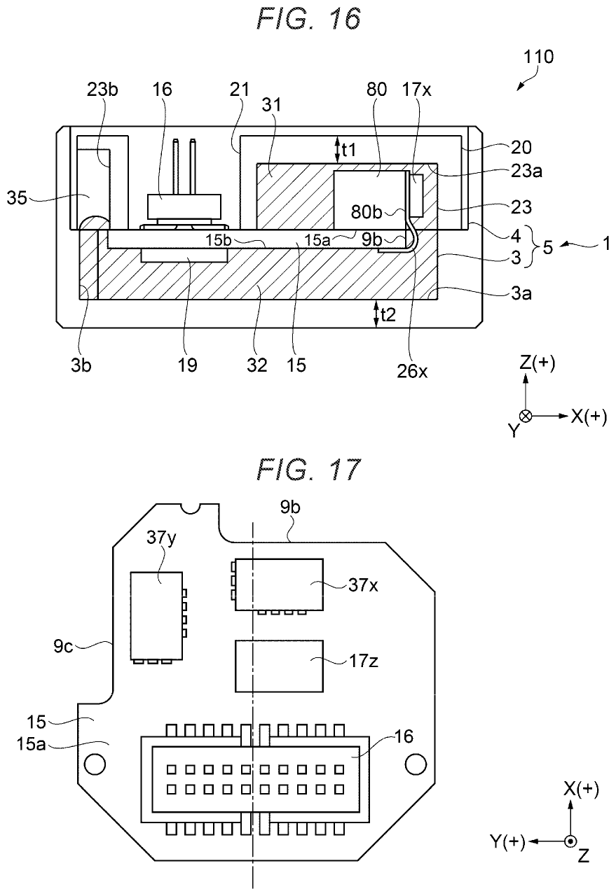

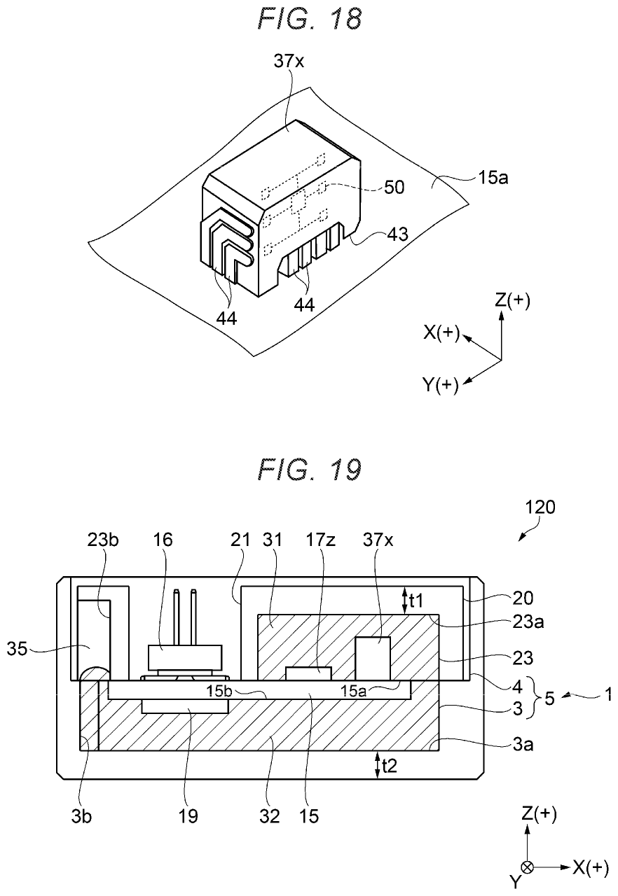

FIG. 17 is a plan view of a circuit board according to a third embodiment, and corresponds to FIG. 12. FIG. 18 is a perspective view of an angular velocity sensor, and corresponds to FIG. 10. FIG. 19 is a cross-sectional view of an inertial measurement device, and corresponds to FIG. 14.

The angular velocity sensors 17x and 17y having horizontal packages are erected using the sub-boards 25x and 25y in the above embodiment, but the disclosure is not limited to this configuration, and angular velocity sensors 37x and 37y having vertical packages may be used. For example, in the embodiment, as shown in FIG. 18, the angular velocity sensors 37x and 37y are used. The angular velocity sensors 37x and 37y include the vertical packages that can be surface-mounted with the vibrating gyro sensor element 50 disposed vertically. Hereinafter, the same portions as those according to the above embodiment are denoted by the same reference signs, and redundant description thereof will be omitted.

As shown in FIG. 17, in the embodiment, the angular velocity sensor 37x including the vertical package having a rectangular shape in a plan view is disposed on the X plus side of the angular velocity sensor 17z including the horizontal package. The angular velocity sensor 37x is disposed such that a long side direction thereof is parallel to the side surface 9b of the circuit board 15 along the extending direction of the Y axis. Accordingly, the angular velocity sensor 37x is orthogonal to the extending direction of the X axis as the detection axis.

The angular velocity sensor 37y including the vertical package is disposed on the Y plus side of the angular velocity sensor 17z including the horizontal package. The angular velocity sensor 37y is disposed such that a long side direction thereof is parallel to the side surface 9c of the circuit board 15 along the extending direction of the X axis. Accordingly, the angular velocity sensor 37y is orthogonal to the extending direction of the Y axis as the detection axis.

The angular velocity sensors 37x and 37y and the angular velocity sensor 17z are all mounted on the first surface 15a of the circuit board 15.

As shown in FIG. 18, the angular velocity sensor 37x includes the vibrating gyro sensor element 50 disposed therein in a longitudinal direction. The longitudinal direction means that the vibrating gyro sensor element 50 is orthogonal to the extending direction of the X axis as the detection axis. In this way, a package type in which the vibrating gyro sensor element 50 is disposed perpendicular to a mounting surface 43 of the angular velocity sensor 37x is referred to as a vertical package.

A plurality of mounting terminals 44 are provided at the mounting surface 43 of the angular velocity sensor 37x. The angular velocity sensor 37y also has the same configuration as that of the angular velocity sensor 37x.

As shown in FIG. 19, in an inertial measurement device 120 according to the embodiment, the angular velocity sensors 37x and 37y and the angular velocity sensor 17z are all accommodated in the cavity 23 of the inner case 20 and covered with the filling material 31.

In other words, according to the inertial measurement device 120, the vibrating gyro sensor element 50 of the angular velocity sensor 37x as the first inertial sensor is disposed perpendicular to the first surface 15a of the circuit board 15. The vibrating gyro sensor element 50 of the angular velocity sensor 37y as the second inertial sensor is disposed perpendicular to the first surface 15a of the circuit board 15, and the angular velocity sensor 17z as the third inertial sensor is mounted on the first surface 15a of the circuit board 15 in parallel.

As described above, according to the inertial measurement device 120 in the embodiment, the following effects can be attained in addition to the effects according to the above embodiment.

According to the inertial measurement device 120, the vibrating gyro sensor element 50 of the angular velocity sensor 37x as the first inertial sensor is disposed perpendicular to the first surface 15a of the circuit board 15. The vibrating gyro sensor element 50 of the angular velocity sensor 37y as the second inertial sensor is disposed perpendicular to the first surface 15a of the circuit board 15, and the angular velocity sensor 17z as the third inertial sensor is mounted on the first surface 15a of the circuit board 15 in parallel.

According to this, the angular velocity sensors 37x and 37y and the angular velocity sensor 17z are all mounted on the first surface 15a of the circuit board 15, and the first surface 15a side is filled with the filling material 31. The second surface 15b side of the circuit board 15 is filled with the filling material 32. Therefore, the circuit board 15 is filled with the filling materials 31 and 32 on the front and back surfaces thereof, and is integrated with the inner case 20 and the outer case 1 to be rigid. This can prevent warping of the circuit board 15. Further, different from the related-art configuration in which the lower sides of the angular velocity sensors 17x and 17y are exposed, the three angular velocity sensors 37x, 37y, and 17z are covered with the filling material 31 all around, and thus the influence of the external environment can be reduced.

Since the front and back surfaces and a peripheral edge portion of the circuit board 15 are almost covered with the filling materials 31 and 32, entry of moisture into the circuit board 15 can be prevented.

Therefore, it is possible to provide the inertial measurement device 120 having excellent moisture resistance and high detection accuracy.

When the angular velocity sensors 17x and 17y are provided at the side surfaces 9b and 9c of the circuit board 15, a circuit mounting process on the side surfaces 9b and 9c is required in addition to a circuit mounting process on the first surface 15a and a circuit mounting process on the second surface 15b. In a configuration using the sub-boards 25x and 25y, a circuit mounting process on the side surfaces is not required, but a preparatory mounting process of mounting the angular velocity sensors 17x and 17y and the pin headers 41 on the sub-boards 25x and 25y is required.

Compared to these, according to a configuration of the embodiment using the angular velocity sensors 37x and 37y including the vertical packages, all the circuit components can be mounted only by a circuit mounting process on the first surface 15a and a circuit mounting process on the second surface 15b, and thus manufacturing efficiency is high.

Therefore, it is possible to provide the inertial measurement device 120 having high manufacturing efficiency, excellent moisture resistance, and high detection accuracy.

### Fourth Embodiment

Different Mounting Mode-3

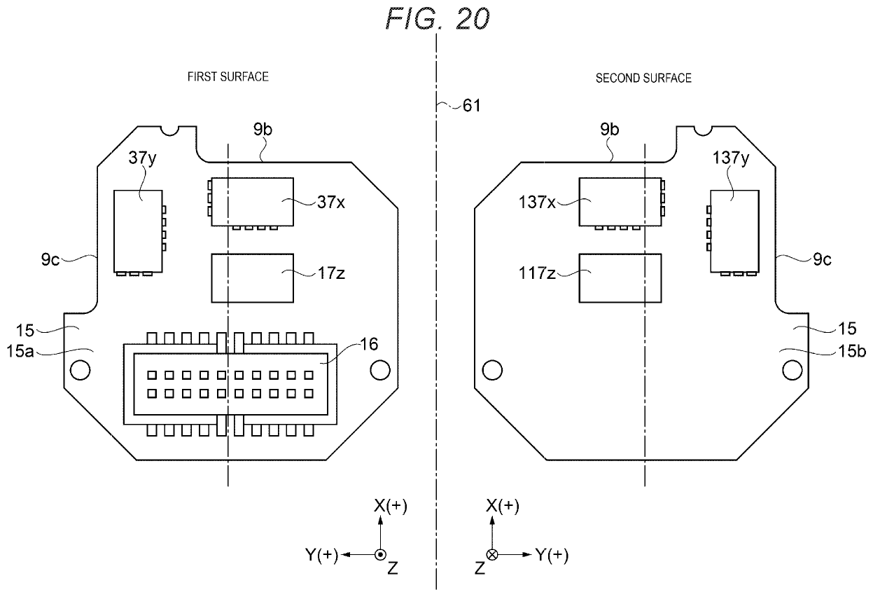

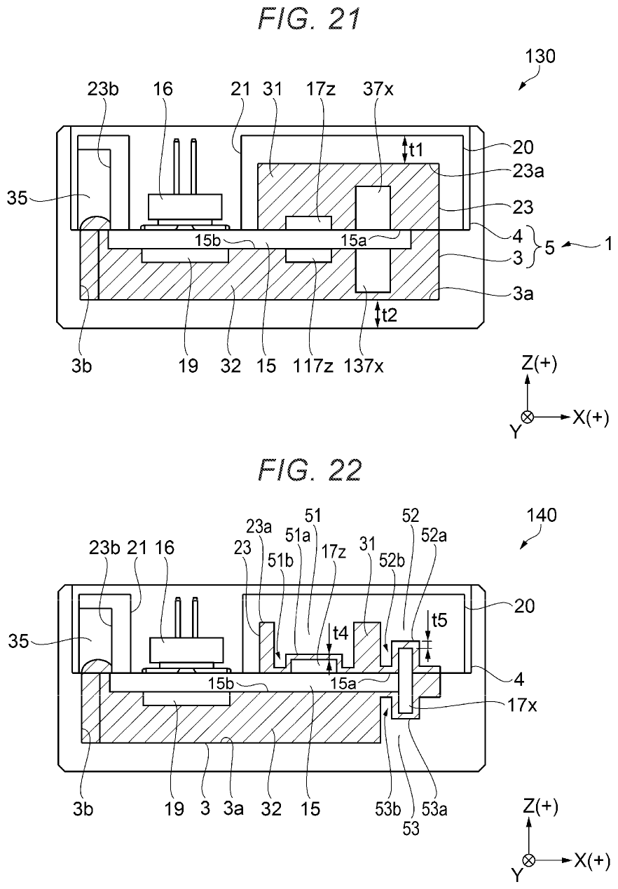

FIG. 20 is a plan view of a circuit board according to a fourth embodiment, and corresponds to FIG. 17. FIG. 21 is a cross-sectional view of an inertial measurement device, and corresponds to FIG. 19.

In the third embodiment, an angular velocity sensor may also be provided at the second surface 15b of the circuit board 15. For example, in the embodiment, as shown in FIG. 20, angular velocity sensors 137x and 137y and an angular velocity sensor 117z are also mounted on the second surface 15b of the circuit board 15. Hereinafter, the same portions as those according to the above embodiment are denoted by the same reference signs, and redundant description thereof will be omitted.

In FIG. 20, the first surface 15a and the second surface 15b of the circuit board 15 are shown left and right with an imaginary line 61 as an axis of symmetry. In other words, mounting modes on the front surface and the back surface of the circuit board 15 are shown side by side.

As shown in FIG. 20, the angular velocity sensor 137x as a fourth inertial sensor, the angular velocity sensor 137y as a fifth inertial sensor, and the angular velocity sensor 117z as a sixth inertial sensor are mounted on the second surface 15b of the circuit board 15.

The angular velocity sensor 137x is the same angular velocity sensor as the angular velocity sensor 37x. The angular velocity sensor 137x is a sensor paired with the angular velocity sensor 37x, and is mounted at a position overlapping a rear side of the angular velocity sensor 37x in a preferable example.

The angular velocity sensor 137y is the same angular velocity sensor as the angular velocity sensor 37y. The angular velocity sensor 137y is a sensor paired with the angular velocity sensor 37y, and is mounted at a position overlapping a rear side of the angular velocity sensor 37y in a preferable example.

The angular velocity sensor 117z is the same angular velocity sensor as the angular velocity sensor 17z. The angular velocity sensor 117z is a sensor paired with the angular velocity sensor 17z, and is mounted at a position overlapping a rear side of the angular velocity sensor 17z in a preferable example.

As shown in FIG. 21, an inertial measurement device 130 according to the embodiment includes the angular velocity sensors 37x and 37y and the angular velocity sensor 17z that are mounted on the first surface 15a of the circuit board 15, and the angular velocity sensors 137x and 137y and the angular velocity sensor 117z that are mounted on the second surface 15b.

The angular velocity sensors 37x and 37y and the angular velocity sensor 17x on the first surface 15a are accommodated in the cavity 23 of the inner case 20 and covered with the filling material 31. The angular velocity sensors 137x and 137y and the angular velocity sensor 117z on the second surface 15b are accommodated in the board accommodating portion 3 of the outer case 1 and covered with the filling material 32.

In other words, the inertial measurement device 130 further includes the angular velocity sensor 137x as the fourth inertial sensor that detects an angular velocity around the X axis as a physical quantity of a first axis, the angular velocity sensor 137y as the fifth inertial sensor that detects an angular velocity around the Y axis as a physical quantity of a second axis, and the angular velocity sensor 117z as the sixth inertial sensor that detects an angular velocity around the Z axis as a physical quantity of a third axis, the vibrating gyro sensor element 50 of the angular velocity sensor 137x is disposed perpendicular to the second surface 15b of the circuit board 15, the vibrating gyro sensor element 50 of the angular velocity sensor 137y is disposed perpendicular to the second surface 15b of the circuit board 15, and the angular velocity sensor 117z is mounted on the second surface 15b of the circuit board 15 in parallel.

A configuration in which three angular velocity sensors are mounted on each of the front and back surfaces of the circuit board 15 can also be applied to the configuration using the sub-boards in FIG. 12. Specifically, the angular velocity sensor 17x mounted on the sub-board 25x, the angular velocity sensor 17y mounted on the sub-board 25y, and the angular velocity sensor 17z are mounted on the first surface 15a of the circuit board 15, and angular velocity sensors corresponding to positions overlapping rear sides of the angular velocity sensors on the front surface are also mounted on the second surface 15b. The angular velocity sensors 17x and 17y on the back surface are mounted on sub-boards as relay boards.

Even with this configuration, the same effects as those according to the inertial measurement device 130 can be attained.

As described above, according to the inertial measurement device 130 in the embodiment, the following effects can be attained in addition to the effects according to the above embodiment.

The inertial measurement device 130 further includes the angular velocity sensor 137x as the fourth inertial sensor that detects the angular velocity around the X axis as the physical quantity of the first axis, the angular velocity sensor 137y as the fifth inertial sensor that detects the angular velocity around the Y axis as the physical quantity of the second axis, and the angular velocity sensor 117z as the sixth inertial sensor that detects the angular velocity around the Z axis as the physical quantity of the third axis, the vibrating gyro sensor element 50 of the angular velocity sensor 137x is disposed perpendicular to the second surface 15b of the circuit board 15, the vibrating gyro sensor element 50 of the angular velocity sensor 137y is disposed perpendicular to the second surface 15b of the circuit board 15, and the angular velocity sensor 117z is mounted on the second surface 15b of the circuit board 15 in parallel.

According to this, by averaging outputs of the angular velocity sensors 37x and 137x mounted on both the front and back surfaces of the circuit board 15, the influence of the stress can be offset, and thus the detection accuracy can be further improved. Similarly, by averaging outputs of the angular velocity sensors 37y and 137y mounted on both the front and back surfaces of the circuit board 15, the influence of the stress can be offset, and thus the detection accuracy can be further improved. By averaging outputs of the angular velocity sensors 17z and 117z mounted on both the front and back surfaces of the circuit board 15, the influence of the stress can be offset, and thus the detection accuracy can be further improved.

Therefore, it is possible to provide the inertial measurement device 130 having excellent moisture resistance and high detection accuracy.

According to a configuration of the embodiment using the angular velocity sensors 37x, 137x, 37y, and 137y including the vertical packages, all the circuit components can be mounted only by a circuit mounting process on the first surface 15a and a circuit mounting process on the second surface 15b, and thus the manufacturing efficiency is high.

Therefore, it is possible to provide the inertial measurement device 130 having high manufacturing efficiency, excellent moisture resistance, and high detection accuracy.

### Fifth Embodiment

Different Mounting Mode-4

FIG. 22 is a cross-sectional view of an inertial measurement device according to a fifth embodiment, and corresponds to FIG. 6.

In the first embodiment, recesses 51a and 52a corresponding to shapes of angular velocity sensors may be formed in the cavity 23 of the inner case 20. Hereinafter, the same portions as those according to the above embodiment are denoted by the same reference signs, and redundant description thereof will be omitted.

As shown in FIG. 22, an inertial measurement device 140 according to the embodiment includes the angular velocity sensor 17z mounted on the first surface 15a of the circuit board 15, and the angular velocity sensors 17x and 17y mounted on side surfaces of the circuit board 15.

The inner case 20 includes protrusions 51 and 52 protruding from the bottom 23a of the cavity 23 toward the circuit board 15.

The protrusion 51 is provided above the angular velocity sensor 17z, and the protrusion 52 is provided above the angular velocity sensor 17x.

The recess 51a formed corresponding to a shape of the angular velocity sensor 17z is formed in a top portion of the protrusion 51. The recess 51a is formed along the shape of the angular velocity sensor 17z, and covers the angular velocity sensor 17z including side surfaces. The recess 51a is surrounded by side walls 51b. In a preferred example, a dimension t4 between a bottom portion of the recess 51a and the angular velocity sensor 17z is set to 2 mm or less. More preferably, the dimension t4 is set to 1 mm or less.

Here, the filling material 31 fills the recess 51a, covers the angular velocity sensor 17z and the surrounding first surface 15a of the circuit board 15, and fills the cavity 23.

The recess 52a formed corresponding to a shape of the angular velocity sensor 17x is formed in a top portion of the protrusion 52. The recess 52a is formed along an upper side shape of the angular velocity sensor 17x, and covers the angular velocity sensor 17x including side surfaces. The recess 52a is surrounded by side walls 52b. In a preferred example, a dimension t5 between a bottom portion of the recess 52a and the angular velocity sensor 17x is set to 2 mm or less. More preferably, the dimension t5 is set to 1 mm or less.

The filling material 31 fills the recess 52a, covers an upper side of the angular velocity sensor 17x and the surrounding first surface 15a of the circuit board 15, and fills the cavity 23.

The outer case 1 includes a protrusion 53 protruding from the bottom 3a of the board accommodating portion 3 toward the circuit board 15. The protrusion 53 is provided below the angular velocity sensor 17x.

A recess 53a formed corresponding to a shape of the angular velocity sensor 17x is formed in a top portion of the protrusion 53. The recess 53a is formed along a lower side shape of the angular velocity sensor 17x, and covers the angular velocity sensor 17x including side surfaces. The recess 53a is surrounded by side walls 53b. A dimension between a bottom portion of the recess 53a and the angular velocity sensor 17x is the same as that of the recess 52a above.

The filling material 32 fills the recess 53a, covers a lower side of the angular velocity sensor 17x and the surrounding second surface 15b of the circuit board 15, and fills the board accommodating portion 3. Similarly to the angular velocity sensor 17x, the angular velocity sensor 17y is also formed with recesses thereabove and therebelow, and is covered with the filling materials 31 and 32.

In other words, the inner case 20 as the case has the recess 52a formed corresponding to the shape of the angular velocity sensor 17x as the first inertial sensor. The outer case 1 as the case has the recess 53a formed corresponding to the shape of the angular velocity sensor 17x.

In the embodiment, the inner case 20 or the outer case 1 has the recess corresponding to the shape of each inertial sensor according to the first embodiment, and this configuration can be applied to the second embodiment, the third embodiment, and the fourth embodiment. That is, the inner case 20 or the outer case 1 may have the recess corresponding to the shape of each inertial sensor according to the second embodiment, third embodiment, and fourth embodiment.

As described above, according to the inertial measurement device 140 in the embodiment, the following effects can be attained in addition to the effects according to the above embodiment.

According to the inertial measurement device 140, the inner case 20 as the case has the recess 52a formed corresponding to the shape of the angular velocity sensor 17x as the first inertial sensor. The outer case 1 as the case has the recess 53a formed corresponding to the shape of the angular velocity sensor 17x.

According to this, the first surface 15a side of the circuit board 15 is filled with the filling material 31, and the second surface 15b side is filled with the filling material 32. That is, the circuit board 15 is filled with the filling materials 31 and 32 on the front and back surfaces thereof, and is integrated with the inner case 20 and the outer case 1 to be rigid. This can prevent warping of the circuit board 15.

Further, by providing the protrusion 51, a thickness of the filling material 31 around the angular velocity sensor 17z is reduced. Accordingly, if the resin forming the filling material 31 absorbs moisture, an expansion amount of the resin present in a thickness direction of the angular velocity sensor 17z is minimized, and the influence of the stress applied to the angular velocity sensor 17z can be further reduced. The same applies to the angular velocity sensors 17x and 17y.

Therefore, it is possible to provide the inertial measurement device 140 having excellent moisture resistance and high detection accuracy.

### Sixth Embodiment

Different Mounting Mode-5

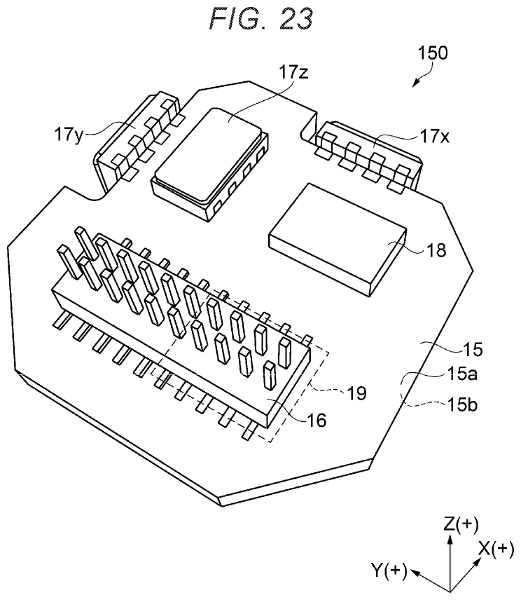

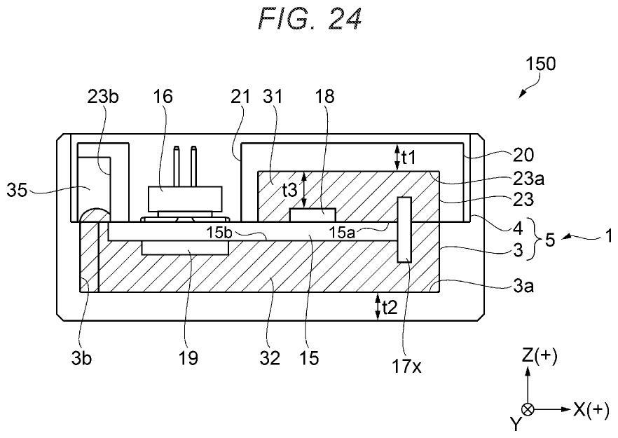

FIG. 23 is a perspective view of a circuit board according to a sixth embodiment, and corresponds to FIG. 4. FIG. 24 is a cross-sectional view of an inertial measurement device, and corresponds to FIG. 6.

The inertial measurement device includes the angular velocity sensors 17x, 17y, and 17z of three axes in the above embodiment, but the disclosure is not limited to this configuration, and may further include an acceleration sensor. Hereinafter, the same portions as those according to the above embodiment are denoted by the same reference signs, and redundant description thereof will be omitted.

As shown in FIG. 23, an inertial measurement device 150 according to the embodiment includes an inertial sensor 18 on the first surface 15a of the circuit board 15 in addition to the angular velocity sensor 17z.

The inertial sensor 18 uses a capacitive acceleration sensor capable of detecting accelerations in three directions (three axes) of the X axis, the Y axis, and the Z axis by one device and obtained by processing a silicon substrate using the MEMS technique. In a preferred example, the inertial sensor 18 is a surface-mounted component including a resin package molded with resin, and is surface-mounted on an electrode pad (not shown) provided at the first surface 15a of the circuit board 15 by soldering. The inertial sensor 18 may be a six-axis combo sensor including a three-axis gyro sensor in addition to the three-axis acceleration sensor. The package is not limited to the resin package, and may be a ceramic package.

As shown in FIG. 24, the cavity 23 of the inner case 20 is filled with the filling material 31, and the board accommodating portion 3 of the outer case 1 is filled with the filling material 32.

The filling material 31 covers the electronic components including the inertial sensor 18 and the angular velocity sensor 17z and fills the cavity 23. Similarly, the filling material 32 covers the electronic components including the control IC 19 and fills the board accommodating portion 3. The angular velocity sensor 17x mounted on the side surface of the circuit board 15 is also covered with the filling materials 31 and 32 on the upper side and the lower side as well as the rear side thereof. Similarly, the angular velocity sensor 17y is covered with the filling materials 31 and 32 all around.

As described above, according to the inertial measurement device 150 in the embodiment, the following effects can be attained in addition to the effects according to the above embodiment.

The inertial measurement device 150 includes the inertial sensor 18 in addition to the angular velocity sensor 17z. Therefore, the inertial measurement device 150 functions as a so-called six-axis motion sensor including the three-axis acceleration sensor and the angular velocity sensors of three axes.

Therefore, it is possible to provide the inertial measurement device 150 that is the six-axis motion sensor and has excellent moisture resistance and high detection accuracy.

What is claimed is:

1. An inertial measurement device comprising:
a board;
a first inertial sensor configured to detect a physical quantity of a first axis and disposed perpendicular to the board;
a rigid case configured to cover the first inertial sensor; and
a filling material disposed between the first inertial sensor and the case.

2. The inertial measurement device according to claim 1, wherein
the first inertial sensor is mounted on a first side surface of the board.

3. The inertial measurement device according to claim 2, further comprising:
a second inertial sensor configured to detect a physical quantity of a second axis and a third inertial sensor configured to detect a physical quantity of a third axis, wherein
the second inertial sensor is mounted on a second side surface different from the first side surface of the board, and
the third inertial sensor is mounted on a first surface of the board in parallel.

4. The inertial measurement device according to claim 1, wherein
the first inertial sensor is mounted perpendicularly to a first surface of the board.

5. The inertial measurement device according to claim 4, further comprising:
a second inertial sensor configured to detect a physical quantity of a second axis and a third inertial sensor configured to detect a physical quantity of a third axis, wherein
the second inertial sensor is mounted perpendicularly to the first surface of the board, and
the third inertial sensor is mounted on the first surface of the board in parallel.

6. The inertial measurement device according to claim 5, further comprising:
a fourth inertial sensor configured to detect a physical quantity of the first axis;
a fifth inertial sensor configured to detect a physical quantity of the second axis; and
a sixth inertial sensor configured to detect a physical quantity of the third axis, wherein
the fourth inertial sensor is disposed perpendicular to a second surface of the board,
the fifth inertial sensor is disposed perpendicular to the second surface of the board, and
the sixth inertial sensor is mounted on the second surface of the board in parallel.

7. The inertial measurement device according to claim 1, wherein
a first relay board is provided on which the first inertial sensor is mounted,
the first relay board is disposed perpendicular to the board, and
the first inertial sensor is electrically coupled to the board via the first relay board.

8. The inertial measurement device according to claim 7, further comprising:
a second inertial sensor configured to detect a physical quantity of a second axis and a third inertial sensor configured to detect a physical quantity of a third axis, wherein
a second relay board is provided on which the second inertial sensor is mounted,
the second relay board is disposed perpendicular to the board,
the second inertial sensor is electrically coupled to the board via the second relay board, and
the third inertial sensor is mounted on a first surface of the board in parallel.

9. The inertial measurement device according to claim 8, further comprising:
a fourth inertial sensor configured to detect a physical quantity of the first axis;
a fifth inertial sensor configured to detect a physical quantity of the second axis; and
a sixth inertial sensor configured to detect a physical quantity of the third axis, wherein
the fourth inertial sensor is disposed perpendicular to a second surface of the board via a third relay board,
the fifth inertial sensor is disposed perpendicular to the second surface of the board via a fourth relay board, and
the sixth inertial sensor is mounted on the second surface of the board in parallel.

10. The inertial measurement device according to claim 1, wherein
the case has a recess formed corresponding to a shape of the first inertial sensor.

11. The inertial measurement device according to claim 1, wherein
the first inertial sensor is a vibrating gyro sensor that uses quartz crystal as a vibrator and detects an angular velocity based on a Coriolis force applied to a vibrating object.

12. The inertial measurement device according to claim 3, wherein
the case has a recess formed corresponding to a shape of at least one of the second inertial sensor and the third inertial sensor.

13. The inertial measurement device according to claim 3, wherein
the second inertial sensor and the third inertial sensor are vibrating gyro sensors that individually use quartz crystal as a vibrator and detect an angular velocity based on a Coriolis force applied to a vibrating object.

14. The inertial measurement device according to claim 6, wherein
the case has a recess formed corresponding to a shape of at least one of the fourth inertial sensor, the fifth inertial sensor, and the sixth inertial sensor.
